(19) United States
(12) Patent Application Publication
(10) Pub. No.: US 2020/0208915 A1
(43) Pub. Date: Jul. 2, 2020

(54) REFLECTION SHIELD FOR A COOKING OVEN CAMERA

(71) Applicant: ELECTROLUX APPLIANCES AKTIEBOLAG, Stockholm (SE)

(72) Inventors: Erhard KÄSER, Rothenburg ob der Tauber (DE); Dietmar HILDNER, Rothenburg ob der Tauber (DE); Branko IVANOVIC, Rothenburg ob der Tauber (DE)

(21) Appl. No.: 16/643,029

(22) PCT Filed: Aug. 20, 2018
(86) PCT No.: PCT/EP2018/072429

§ 371 Date: Feb. 28, 2020

(30) Foreign Application Priority Data
Aug. 30, 2017 (EP) 17188496.8

(51) Int. Cl. F27D 21/00; F24C 15/36; F24C 15/04; F27D 19/00

(52) U.S. Cl. CPC F27D 21/00; F24C 15/36; F27D 2021/026; F27D 19/00; F24C 15/04

(57) ABSTRACT

In order to avoid that the picture signal obtained from an oven camera that is mounted at the exterior side of an oven door is disturbed by reflections, it is suggested to provide a reflection shield (40) for an oven camera (18) that is mounted at the exterior side of an oven door (30; 14) for monitoring an oven cavity (12) of a cooking oven (10), the reflection shield (40) comprising: a shield element (40) for covering a portion of the oven door (30; 14), a viewing window (46) for the camera (18); and at least one clamp (42) for clamping the reflection shield (40) to a handle (36; 16) of the oven door (30; 14).

Modern cooking ovens sometimes are equipped with camera systems for monitoring the interior of the cooking chamber, so as to either provide automated cooking functions such as the setting of parameters in dependency of the recorded data, such as in a baking process an adjustment of the oven temperature in dependency of the degree of browning of the food product being prepared, or in order to allow remote monitoring of the cooking progress such as by transmitting picture data to a remote device, for example a mobile phone.

While locating a camera within the oven cavity is problematic due to the difficult conditions prevailing within the oven cavity during a cooking process, such as high temperature and high humidity, it was suggested for example in WO 2016/034295 to locate the camera at the exterior side of the front door of the oven, where the camera is to be positioned so as to view through a transparent window in the front door, into the oven cavity.

An advantageous position for installation of a camera is at the door handle, which in most cooking ovens is provided in an upper portion of the door. Installing the camera at the door handle not only offers a view into the oven which is similar to the view from the perspective of a user, but also is to be preferred for constructional reasons and for design reasons over a dedicated fixture for holding the camera.

A problem sometimes encountered during use of oven cameras that are installed at the exterior of the oven door, such as at the door handle, is that the camera view can be disturbed by reflections at the glass panes of the over door. Depending on the incidence of light from the environment of the cooking oven, reflections can disturb the picture transmitted to a user or, if the camera signal is used for an automated control of the oven, can distort and falsify the camera data which thus can negatively affect the cooking process.

In view of the foregoing, it is an object of the present invention to provide a remedy for such reflection problem.

The present invention solves the above object by providing for a reflection shield for an oven camera that is mounted at the exterior side of an oven door for monitoring an oven cavity of a cooking oven, wherein the reflection shield comprises a shield element for covering a portion of the oven door, a viewing window for the camera, and at least one clamp for clamping the reflection shield to a handle of the oven door.

The present invention provides for a simple but yet particularly effective solution to the problem of reflections that may occur at the glass surfaces of an oven door, such as reflections of incident light at the outer or inner surfaces of any of the glass panes through which the interior of the oven cavity is monitored by the camera. Such reflections typically can be caused by sunlight or artificial light that shines on the oven door in dependency of the individual environment of the place of installation of the cooking oven, such as the distances and orientation in relation to the cooking oven of light sources such as windows and lamps, but which also for a given installation varies over time, such as by a variation in sun light, by switching on or off light sources in the vicinity of the oven, or by stationary or moving objects such as a person in the vicinity of the oven, which object or person may block off light or may itself cause reflections. To effectively block any such reflections, the size of the reflection shield is selected in dependency of the viewing angle of the camera, so that preferably the entire area of the camera view is shielded. In a standard cooking oven of 60 cm width such function can be achieved for example with a reflection shield of a generally rectangular shape, the sides of which have a length of about 10 to 12 cm, and maximum of about 15 cm. While such a reflection shield still leaves sufficient unoccupied area of the window for a user to directly look into the oven cavity, should the user prefer to have a better view into the oven cavity without opening the oven door, the reflection shield can be easily removed and again quickly be reinstalled, by clamping it to, or removing it from, the handle of the oven door.

Preferred embodiments of the present invention are defined in the dependent claims.

In particular, the at least one clamp preferably is designed to be clamped between the oven door and the door handle, which allows for an easy, quick and yet reliable mounting of the reflection shield which further does not require any redesign of the door handle. The reflection shield can be quickly installed in case that due to the present light conditions the camera picture might be disturbed by reflections, wherein no tools are required for installing the reflection shield or for again removing the same should the use thereof no longer be deemed necessary, but instead the user prefers and unobstructed view through the window in the oven door.

In order to provide for a clamping force for fixation of the reflection shield, the at least one clamp, when in the released state, preferably has a dimension measured orthogonal to the outer surface of the oven door which is larger than the distance of the door handle from the oven door. With such a dimensioning the at least one clamp is deformed and hence biased when inserting the one or more clamps of the reflection shield between the handle and the handle door.

To provide for a stable fixation of the reflection shield in the mounting position, the at least one clamp preferably is shaped such that during insertion of the clamp, the clamp is biased, and in the fully mounted position is at least partially released. Such shaping of the clamp in relation to the door handle provides for an “over-the-center” or “snap-in” connection. Thus, for example when the door handle is a tubular element having a circular cross-section, the clamp can be designed to have a generally concave shape in the region where it engages the door handle, so that the clamp during insertion of the reflection shield into the gap between the oven door and the door handle is compressed by the door handle acting on the clamp, wherein a maximum bias is reached when the portion of the clamp which engages the door handle reaches the level of the center of the door handle, where the gap between the oven door and the door handle has a minimum width, and wherein when pushing the reflection shield and thus the clamp further beyond such point, the clamp at least partially releases. Given that for removal of the reflection shield the clamp again would have to be compressed, such bias maintains the reflection shield in place.

To provide for a large area of contact between the clamp and the door handle, the at least one clamp preferably has an abutment surface with which the clamp rests against the door handle, wherein the abutment surface is shaped to be complementary to the cross-sectional shape of the door handle.

In preferred embodiments the reflection shield comprises two clamps between which there is located the viewing window for the camera, for example two clamps that are located along the lateral edges of the reflection shield, so that the camera is located in a central position, which in most cases provides for the best shielding against reflections caused by incident light.

The reflection shield can be manufactured at particularly low costs when it is formed as a single piece component, such as a component that is made of a plastic material having sufficient strength but yet flexibility to provide for a clamping force for the at least one clamp.

In a preferred embodiment, the present invention further provides a camera assembly to be mounted at the exterior side of an oven door for monitoring an oven cavity of a cooking oven, wherein the assembly comprises a camera having mounting means for mounting the camera at a door handle located at the exterior side of the oven door, and a reflection shield as it was described above. Such camera assembly can be provided as a kit to be installed at a given cooking oven.

To provide for fixation of the camera at the door handle, the mounting means either can comprise at least one fixation for attaching the camera at the door handle, or the mounting means can comprise a door handle which has a recess in which there is mounted the camera. Thus, while in the first case the camera is attached at the exterior of the door handle, in the second case the camera is installed at least in part within the door handle, which allows a particularly stable and hence reliable mounting of the camera. Further, in such embodiments the camera is integrated at least partially within the door handle, which provides for a stable and protected fixation of the camera, and which further is advantageous in terms of design aspects. In embodiments, in which the camera is not fully integrated within the door handle, but instead has a camera housing that is attached to the door handle, the protection shield can be designed so as to abut against the camera housing and/or to be supported at least in part by the camera housing. Such abutment of the protection shield against the camera housing facilitates the shielding off of any incident light and at the same time provides for a particularly stable mounting of the protection shield.

In preferred embodiments, the door handle can be an elongate hollow element which has an aperture in which there is mounted the camera. In such embodiments, the door handle further can comprise at least two support elements for mounting the handle to the oven door, wherein at least one of the two support elements comprises a wire feed-through for the passage of wires for connection of the camera. Thus, the camera can be connected via wires that extend through the door to a control device of the cooking oven, so as to provide for processing, display and/or transmittal to a remote device of data that has been received from the camera.

The present invention further provides for a cooking oven which comprises an oven cavity, an oven door having a viewing window, a door handle mounted at the exterior side of the over door, and a camera assembly as it was described above which is attached to the door handle. In preferred embodiments such a cooking oven further comprising at least one of display means for displaying pictures obtained by the camera, control means coupled to the camera for controlling oven functions in dependency of picture data received from the camera, and transmission means for transmitting picture data to a remote display means, such as a remote computer, a tablet or a mobile phone.

Preferred embodiments of the present invention are described below by reference to the drawings

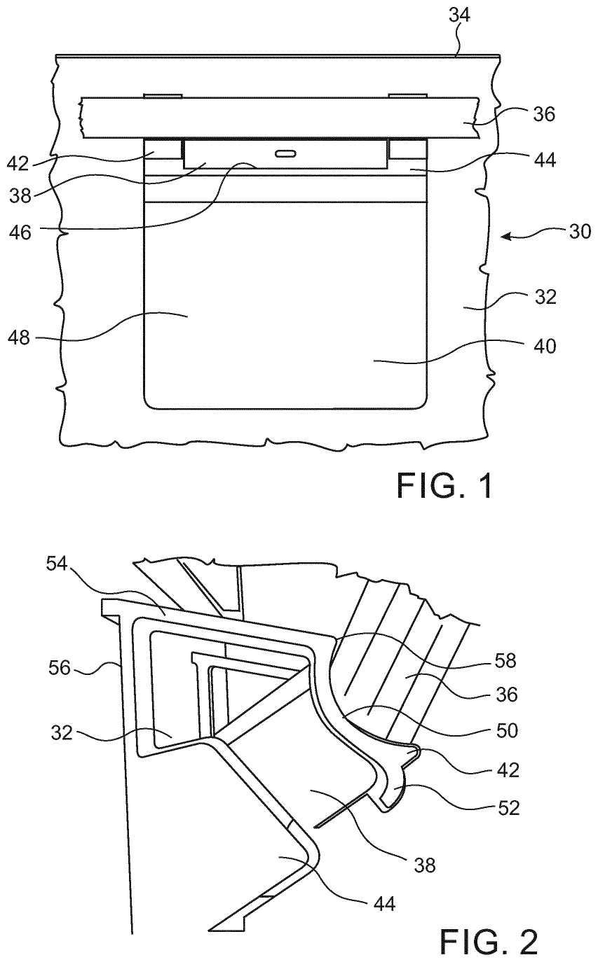

FIG. 1 is a front view of a reflection shield in accordance with the present invention;

FIG. 2 is a perspective side view of the reflection shield of FIG. 1; and

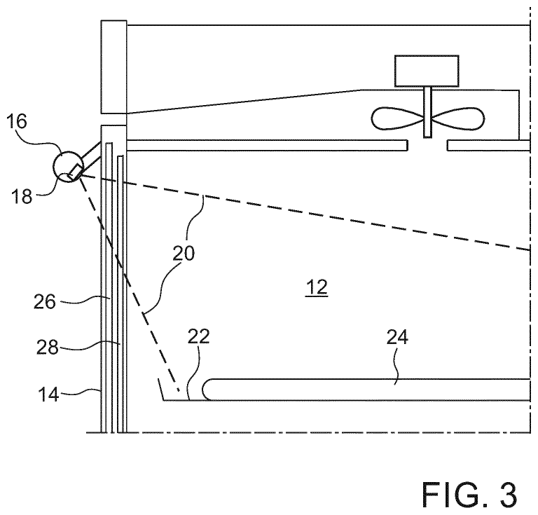

FIG. 3 illustrates an oven with which the reflection shield of FIGS. 1 and 2 can be used.

FIG. 1 shows a portion of an oven door 30 for closing a cooking chamber of a cooking oven which can be similar to the oven illustrated in FIG. 3.

In particular, FIG. 3 illustrates a schematic partial sectional side view of a cooking oven 10 which is equipped with a camera 18 and which can be implemented as it is disclosed in WO 2016/034295. The cooking oven 10 includes a cooking chamber 12 which is openable and closable by an oven door 14 provided at the front side of the cooking oven. The oven door 14 comprises an door handle 16 arranged at an upper portion of an outer side of said oven door 14. The oven door 14 includes a transparent window. In the example shown, the oven door 14 includes an outer glass panel 26 and an inner glass panel 28.

The camera 18 is attached to the door handle 16, and as shown in FIG. 3, can be located at least partially inside the door handle 16. A lens coverage 20 of the camera 18 is directed from camera 18 through the oven door 14 to a food item 24 disposed on a cooking tray 22 inside the cooking chamber 12. Picture data recorded by camera 18 can be transmitted to a control unit of the cooking oven so as to provide for automated cooking functions and/or can be transmitted to a display device so as to be viewed by a user of the cooking oven.

Turning back to FIG. 1, oven door 30 comprises a window 32, which as explained by reference to FIG. 3 may comprise one or more glass panes. Thus, particularly when window 32 is designed as a so-called cool front window, the outer surface of which does not get hot even when the oven cavity is heated to high temperatures, window 32 will comprises at least an outer glass panel and an inner glass panel, the surfaces of which all may cause reflections.

In the proximity of the upper edge 34 of the oven door 30 there is provided a door handle 36, which in the embodiment shown in FIG. 1 is an elongate bar element of substantially circular cross-section which is mounted horizontally at the door. In a central section of the door handle 36 there is provided a camera housing 38, which as can be best seen in FIG. 2 is mounted in an aperture that is provided at a portion of the door handle 36 facing towards window 32. Camera housing 38 is installed at door handle 36 so as to be directed downwardly askew towards window 32, so as to obtain a view of basically the entire oven cavity, similarly as is illustrated in FIG. 3.

To avoid that reflections at any of the panes of window 32 reach the camera, such as reflections from the side or from below, a reflection shield 40 is attached to door handle 36. As illustrated in FIGS. 2 and 3, reflection shield 40 in its upper region comprises a housing portion 44 which carries a substantially flat shield portion 48 which in the assembled state rests against the window 32 of oven door 30. As can be best seen in FIG. 2, reflection shield 40 is held at door handle 36 by means of two clamps 42 which are located at the two lateral end portions of housing portion 44.

Clamps 42 each comprise an abutment surface 50 the contour of which is complementary to that of door handle 36. Clamp 42 at its lower free end comprises an engagement section 52 which is adapted to facilitate engagement by a user to apply a pushing force, by which clamp 42 can be bend away from door handle 36 in case that the reflection shield 40 is to be removed. Thus, by applying a pushing force onto engagement section 52 an upper arm 54 is slightly bend towards a horizontal portion 56 of reflection shield 40, which in the mounted state shown in FIG. 2 extends parallel to window 32. To facilitate mounting of the reflection shield 40 by inserting reflection shield 40 into the gap formed between door handle 36 and the oven door 30, the upper arm 54 is attached to the horizontal portion 56 so as extend slightly downwards. As can be seen in FIG. 2, clamp 42 is shaped to extend beyond the point where the distance between the door handle 36 and the oven door 30 is at a minimum. Thus, in the embodiment shown in FIGS. 1 and 2 in which the door handle has a circular cross section, the abutment surface 50 of the clamp extends with its upper corner 58 to a level that is above a horizontal line that extends through the center of the cross section of door handle 36, so that when corner 58 passes such level, the clamp at least partially releases to thus hold the clamp in place.

It is to be understood that the clamping action can be obtained by various shapes of the clamp, wherein an appropriate shape is selected in dependency of the cross sectional shape of the door handle. Thus, for example in case that the door handle has a rectangular shape, the clamp 42 can be designed to have an abutment surface that is complementary to such rectangular shape, i.e. instead of the concave abutment surface 50 shown in FIG. 2 the clamp can be provided with an L-shaped abutment surface, which at its upper end further is provided with a short projection that acts as a lock to prevent the clamp from slipping downwards. Instead of providing a lock at the upper end of the abutment surface, there also could be provided a lock in an intermediate region of the abutment surface, such as a pin that projects outwardly from the abutment surface into a corresponding aperture or recess provided in the door handle.

### REFERENCE SIGNS

10 cooking oven
12 cooking chamber
14 oven door
16 door handle
18 camera
20 lens coverage
22 cooking tray
24 food item
26 glass panel
28 inner glass panel
30 oven door
32 window
34 upper edge of 30
36 door handle
38 camera housing
40 reflection shield
42 clamp
44 housing portion
46 recess (viewing window)
48 shield portion
50 abutment surface
52 engagement section
54 upper arm
56 horizontal portion
58 upper corner of 50

1. A reflection shield for an oven camera that is mounted at the exterior side of an oven door for monitoring an oven cavity of a cooking oven, the reflection shield comprising:
a shield element for covering a portion of the oven door,
a viewing window for the camera, and
at least one clamp for clamping the reflection shield to a handle of the oven door.

2. The reflection shield of claim 1, wherein the at least one clamp is designed adapted to be clamped between the oven door and the door handle.

3. The reflection shield of claim 2, wherein the at least one clamp, when in a released state, has a dimension measured orthogonal to an outer surface of the oven door which is larger than the a distance of the door handle from the oven door.

4. The reflection shield of claim 3, wherein the at least one clamp, is shaped such that during insertion of the clamp, the clamp is biased, and in a fully mounted position is at least partially released.

5. The reflection shield according to claim 2, wherein the at least one clamp has an abutment surface with which the clamp rests against the door handle, wherein the abutment surface is shaped to be complementary to the a cross-sectional shape of the door handle.

6. The reflection shield according to claim 2, said at least one clamp comprising two clamps between which there is located the viewing window.

7. The reflection shield according to claim 1, wherein said reflection shield is formed as a single piece component.

8. A camera assembly to be mounted at an exterior side of an oven door for monitoring an oven cavity of a cooking oven, the assembly comprising:
a camera having mounting means for mounting the camera at a door handle located at the exterior side of the oven door; and
the reflection shield according to claim 1.

9. The camera assembly of claim 8, wherein the mounting means comprises at least one fixation for attaching the camera at the door handle.

10. The camera assembly of claim 8, wherein the mounting means comprises a door handle having a recess in which there is mounted the camera.

11. The camera assembly of claim 10, wherein the door handle is an elongate hollow element having an aperture in which there is mounted the camera.

12. The camera assembly of claim 11, wherein the door handle comprises at least two support elements for mounting the handle to the oven door wherein at least one of the two support elements comprises a wire feed-through for the passage of wires for connection of the camera.

13. A cooking oven comprising:
an oven cavity;
an oven door having a viewing window;
a door handle mounted at the an exterior side of the over door; and
the camera assembly according to claim 7 attached to the door handle.

14. The cooking oven of claim 13 further comprising at least one of:
display means for displaying pictures obtained by the camera;
control means coupled to the camera for controlling oven functions in dependency of picture data received from the camera; and
transmission means for transmitting picture data to a remote display means, such as a remote computer, a tablet or a mobile phone.

15. A cooking oven comprising A cooking oven comprising:
an oven cavity;
an oven door having a viewing window;
a door handle mounted at an exterior side of the over door;
a camera installed at said handle and directed downwardly askew toward said window and adapted to obtain images of cooking foodstuffs within said oven cavity through said window; and
a reflection-shield assembly adapted to be installed between said door handle and said window to reduce reflections that may obscure images of said foodstuffs obtained by said camera, the reflection-shield assembly comprising a substantially flat shield portion and a pair of clamps located at opposing lateral ends of said assembly;
each said clamp comprising:
an abutment surface whose contour is complementary to a cross-sectional shape of said handle at a location where the clamp abuts the handle when installed,
an upper corner of, or a projection from, said abutment surface adapted to provide a snap-fit connection of said assembly relative to said door handle when installed, and
an engagement section at a lower free end of said abutment section adapted to be engaged and pushed by a user to deflect said abutment surface away from said handle in order to disengage said snap-fit connection and thus permit removal of said assembly from said door handle when installed;
wherein the aforementioned snap-fit connection can be engaged upon installation of said assembly and disengaged upon removal thereof without tools.

16. A reflection-shield assembly adapted to be installed between a door handle and a window of an oven door, comprising a housing portion, a substantially flat shield portion, and a pair of clamps located at opposing lateral ends of said housing portion;
each said clamp comprising:
an abutment surface whose contour is complementary to a cross-sectional shape of said handle at a location where the clamp is to abut the handle when installed,
an upper corner of, or a projection from, said abutment surface adapted to provide a snap-fit connection of said assembly relative to said door handle when installed, and
an engagement section at a lower free end of said abutment section adapted to be engaged and pushed by a user to deflect said abutment surface away from said handle in order to disengage said snap-fit connection and thus permit removal of said assembly from said door handle when installed;
wherein the aforementioned snap-fit connection can be engaged upon installation of said assembly and disengaged upon removal thereof without tools.

17. The reflection-shield assembly of claim 16, said substantially flat shield portion adapted to rest against said window of said door when installed; said upper corner of said abutment surface of each said clamp being adapted such that as said upper corner is urged upon installation of said clamp assembly beyond a point of minimum distance between said handle and said window, said corner is partially released from compression therebetween against its bias, and snaps over said handle to hold said clamp in place.
